(19) United States
(12) Patent Application Publication
(10) Pub. No.: US 2023/0182316 A1
(43) Pub. Date: Jun. 15, 2023

(54) Device For Carrying Out Interventions On An Electrical Transmission Line Assembly

(71) Applicant: Enedis, Paris La Defense Cedex (FR)

(72) Inventors: Francis Lonardi, Dieuze (FR); Emmanuel Del Sordo, Dombasle Sur Meurthe (FR)

(73) Assignee: Enedis, Paris La Defense Cedex (FR)

(21) Appl. No.: 17/923,664

(22) PCT Filed: May 17, 2021
(86) PCT No.: PCT/EP2021/062915

§ 371 Date: Nov. 7, 2022

(30) Foreign Application Priority Data
May 15, 2020 (FR) FR2004833

(51) Int. Cl. B25J 11/00; H02G 1/02; B25J 9/00

(52) U.S. Cl. CPC B25J 11/00; H02G 1/02; B25J 9/0084; B25J 5/005

(57) ABSTRACT

A device for carrying out interventions on an electrical transmission line assembly, including a self-propelled lifting machine having a mobile end support member and at least one robot arm provided with tools for remote-controlled execution of a given task. The robot arm is attached to a platform attached to at least two electrical insulation tubes located at a distance from, and opposite to, one another, one portion of the electrical insulation tubes being attached to the end support member of the self-propelled lifting machine.

The invention concerns a device for carrying out interventions on an electrical transmission line assembly.

The field of the invention concerns the electricity distribution grids, in particular overhead power lines.

Work on these lines presents a hazard for people.

Currently, when working on the overhead network, technicians work at height using insulating poles, from lifts or ladders. One of the difficulties of automating this work by a robot is that the robot may have to manipulate portions of the electrical transmission line assembly which are not the same electrical potential.

A goal of the invention is to obtain a device for carrying out interventions on an electrical transmission line assembly, which overcomes the disadvantages mentioned above and to make it possible to automate, using one or more robot arms, the manipulation of portions which are not at the same electrical potential.

For this purpose, a first subject matter of the invention is a device for carrying out interventions on an electrical transmission or distribution line assembly, comprising a self— propelled lifting machine for lifting a mobile end support relative to a lower base of the machine, at least one robot arm, which is provided with tools for remote—controlled execution of a given task on the line assembly and which is attached to the support, characterised in that the robot arm is attached to a platform that is respectively attached to at least two electrically insulating tubes located at a distance from one another and facing each other, a portion of the electrically insulating tubes being attached to the end support of the self—propelled lifting machine.

Through the invention, the technicians remain on the ground and can control a robot which is at height and which performs the work.

According to an embodiment of the invention, the device comprises at least one first robot arm and at least one second robot arm, which are provided with the tools for remote— controlled execution of a given task on the electrical transmission line assembly and which are attached to the support,

the first robot arm and the second robot arm are respectively attached to a left platform and to a right platform, which are respectively attached to a left side and a right side of the at least two electrically insulating tubes,

the left sides of the electrically insulating tubes being located distant from one another and facing each other,

the right sides of the electrically insulating tubes being located distant from one another and facing each other,

the left side of each electrically insulating tube being connected to its right side by a middle portion of this electrically insulating tube and being distant from its right side,

the middle portions of the electrically insulating tubes being attached to the end support of the self—propelled lifting machine.

Through the invention, the two robot arms are held at a distance from one another being electrically insulated from one another by a safety distance formed between the platforms by the middle portions of the electrically insulating tubes, in order to allow work on a high—voltage line. Moreover, this safety distance, formed by the middle portions of the electrically insulating tubes between the platforms of the robot arms, is used to attach the end support of the lifting machine, which is therefore electrically insulated relative to each of the two robot arms. The tubes therefore provide high voltage electrical insulation between three elements simultaneously, namely the two robot arms and the end support of the lifting machine.

According to an embodiment of the invention, the portions of the electrically insulating tubes, to which the end support of the self—propelled lifting machine is attached, are located distant from one another and facing each other.

According to an embodiment of the invention, each electrically insulating tube has an electrical strength greater than 50 kV per 30 cm length of tube.

According to an embodiment of the invention, each electrically insulating tube comprises a longitudinal cylinder, which is made of glass fibres and epoxy resin, the longitudinal cylinder being filled with a polyurethane foam.

According to an embodiment of the invention, the end support is separated by a safety distance of at least 10 centimetres relative to the platform along each of the electrically insulating tubes.

According to an embodiment of the invention, the end support of the self—propelled lifting machine comprises a left side beam and a right side beam, which are distant from one another, which extend transverse to the portions of the electrically insulating tubes, which are attached to the portions of the electrically insulating tubes and which are connected to one another by a connection element,

the connection element being attached to the end of at least one upper lifting element of the lifting machine,

the upper lifting element being mobile relative to the lower base.

According to an embodiment of the invention, the lifting machine comprises at least one lifting element articulated via at least one axis of rotation relative to the base.

According to an embodiment of the invention, the platform is attached to at least one of the electrically insulating tubes via at least one sleeve enclosing the electrically insulating tube, the portion of the electrically insulating tubes being attached to the end support of the self—propelled lifting machine via at least one other sleeve respectively enclosing the portion of the electrically insulating tubes.

According to an embodiment of the invention, each sleeve comprises a first part delimiting a first semi—cylindrical interior space, a second part delimiting a second semi— cylindrical interior space, first and second axes of rotation extending along the semi—cylindrical interior spaces and distant from one another, clamping means and a connection pin,

the second part being articulated relative to the first part by the first axis of rotation,

the clamping means being articulated relative to the second part by the second axis of rotation,

the first part comprising a clamping hook, which is located distant from the first axis of rotation and which delimits an opening capable of receiving the clamping means,

the second part comprising a through—hole transverse to the first and second axes of rotation, the connection pin being capable of being attached in the transverse through—hole and comprising an outer connecting head,

the sleeve being capable of occupying a release position, in which the second part and the first part are open relative to one another and the clamping means are at a distance from the opening of the clamping hook in order to allow one of the electrically insulating tubes to be inserted in the first and second semi—cylindrical interior spaces,

the sleeve being able to occupy a clamping position, in which the first part and the second part are closed on one another, said electrically insulating tube is clamped in the first and second semi—cylindrical interior spaces between the first part and the second part, the clamping means are clamped against the opening of the clamping hook, in order to attach the sleeve on the electrically insulating tube, the connection pin is attached in the transverse through—hole and the outer connecting head is positioned on the outside of the second part and is attached to the platform or to the end support.

According to an embodiment of the invention, the lifting machine comprises at least four lifting elements articulated with respect to one another by four axes of rotation relative to the base.

According to an embodiment of the invention, the first robot arm and the second robot arm are intended to be in contact with, respectively, first and seconds portions at a distance from one another of the high—voltage electrical transmission line assembly.

According to an embodiment of the invention, the device comprises at least one visualisation camera of the first robot arm and/or the second robot arm.

According to an embodiment of the invention, the device comprises a remote—control unit for remote-control of the first robot arm and of the second robot arm via a wireless connection.

The invention will be better understood on reading the following description, given by way of a non—limiting example only, and with reference to the figures below of the attached drawings.

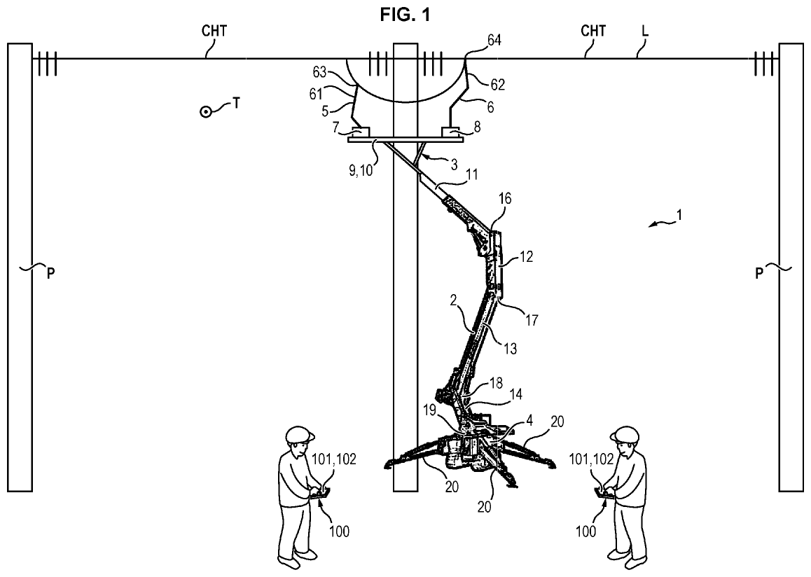

FIG. 1 is a schematic perspective view of a device for carrying out interventions on a high—voltage electrical transmission line assembly, according to an embodiment of the invention.

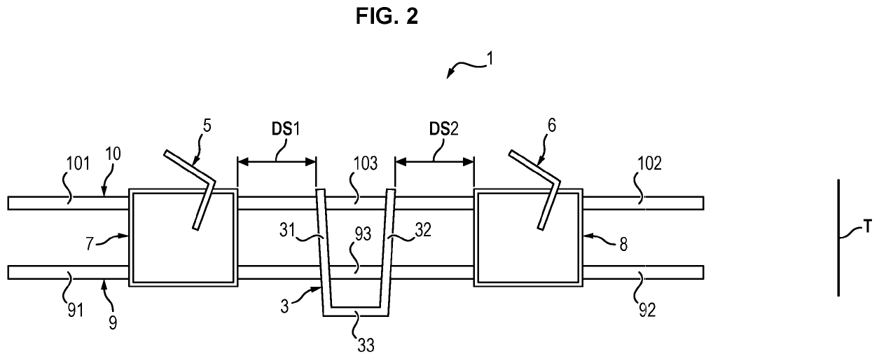

FIG. 2 is a schematic view from above of a portion of the device for carrying out interventions on a high—voltage electrical transmission line assembly, according to an embodiment of the invention.

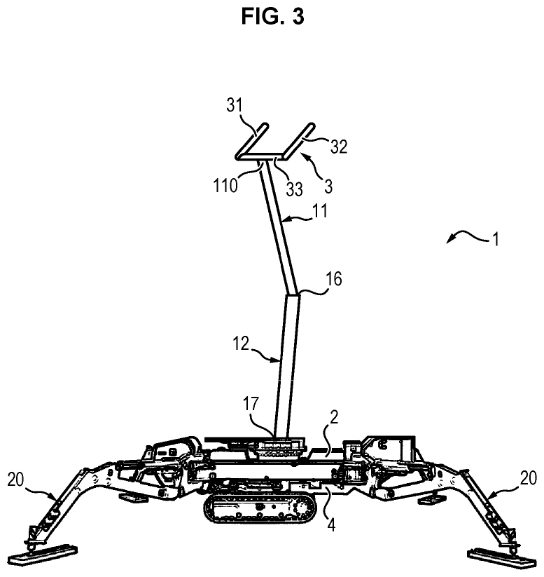

FIG. 3 is a schematic perspective view of a portion of the device for carrying out interventions on a high—voltage electrical transmission line assembly, according to an embodiment of the invention.

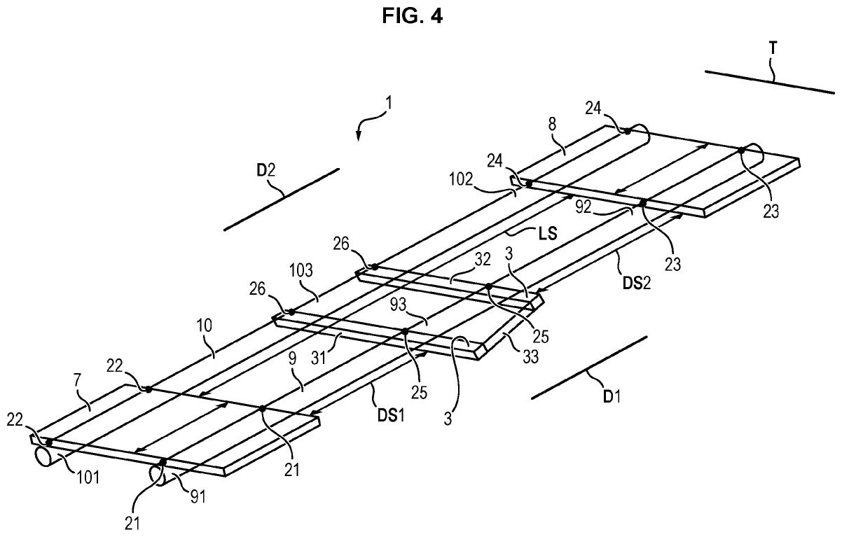

FIG. 4 is a schematic perspective view of a portion of the device for carrying out interventions on a high—voltage electrical transmission line assembly, according to an embodiment of the invention.

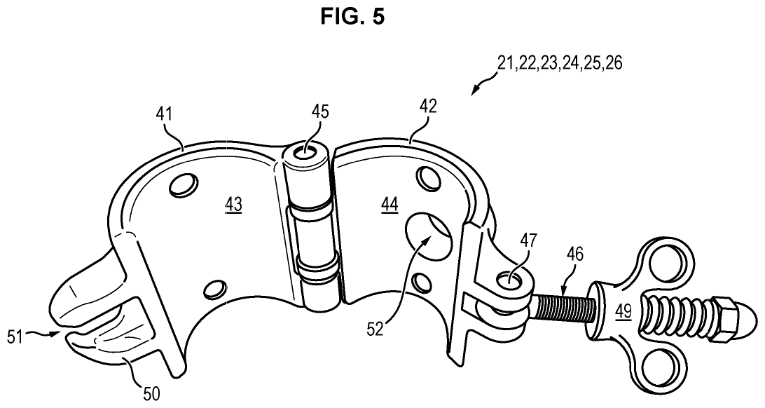

FIG. 5 is a schematic perspective view of a portion of a clamping sleeve that can be used in the device for carrying out interventions on a high—voltage electrical transmission line assembly, according to an embodiment of the invention, in a released position.

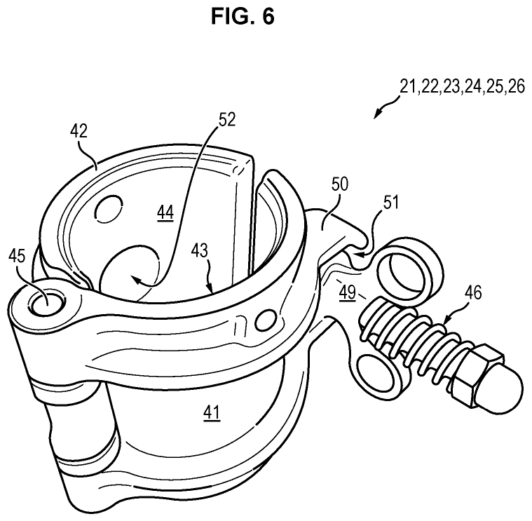

FIG. 6 is a schematic perspective view of a portion of a clamping sleeve that can be used in the device for carrying out interventions on a high—voltage electrical transmission line assembly, according to an embodiment of the invention, in a clamped position.

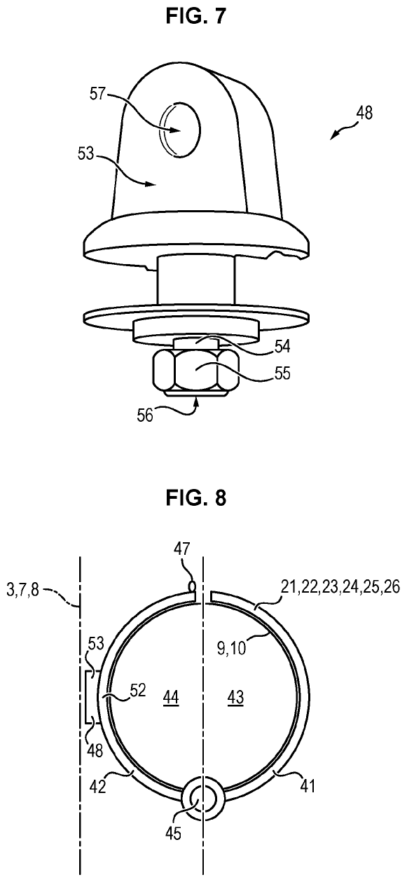

FIG. 7 is a schematic perspective view of a portion of a clamping sleeve that can be used in the device for carrying out interventions on a high—voltage electrical transmission line assembly, according to an embodiment of the invention.

FIG. 8 is a schematic view of a side of a clamping sleeve that can be used in the device for carrying out interventions on a high—voltage electrical transmission line assembly, according to an embodiment of the invention, in a clamped position.

An example of a device 1 for carrying out interventions on an electrical transmission or distribution line assembly L is described below in more detail with reference to FIGS. 1 to 4. The electrical transmission or distribution line assembly L can be at high voltage, for example of order 20,000 Volts (or another high—voltage value). Of course, the electrical transmission or distribution line assembly L can be other than at high voltage and can, for example, be at a lower voltage than the high voltage.

In FIG. 1, the electrical transmission line assembly L can be of the overhead electrical line type and comprise several electrical conductors CHT, each separated and sheathed by an insulating layer, which are suspended on the upper portion of pylons P in order to hold the electrical conductors CHT at a certain height above the ground. The electrical transmission line assembly L can transmit a high alternating—current voltage, for example greater than 10 kV, and for example equal to 20 kV or the like, which may or may not be three—phase.

In FIGS. 1 to 4, the device 1 for carrying out interventions comprises a self—propelled lifting machine 2, which can be controlled by a person in order to move over the ground to a chosen position under and/or close to the electrical transmission line assembly L. The self— propelled lifting machine 2 comprises a lower base 4, which is self—propelling and can, for example, travel on the ground using caterpillar tracks, wheels or the like. The self—propelled lifting machine 2 comprises at least one upper end support 3, which is movable, at least in height, relative to the lower base 4. The self—propelled lifting machine 2 may comprise legs 20 for immobilisation on the ground, able to be deployed around the base 4 when stationary. Hence, the self—propelled lifting machine 2 may be of the crane type, for example of the type referred to as a spider.

In FIGS. 1 and 2, the device for carrying out interventions 1 comprises at least one robot arm 5. The robot arm 5 is provided with tools for remote—controlled execution of a given task on the line assembly L. The robot arm 5 is attached to the support 3. The robot arm 5 is attached to a platform 7, that is respectively attached to at least two electrically insulating tubes 9 and 10. The two electrically insulating tubes 9 and 10 are located at a distance from one another, and face each other. A portion 93 of the electrically insulating tube 9 is attached to the end support 3 of the self—propelled lifting machine 2. A portion 103 of the electrically insulating tube 10 is attached to the end support 3 of the self—propelled lifting machine 2. According to an embodiment of the invention, the portions 93, 103 are located at a distance from one another and face each other.

According to an embodiment of the invention, shown in FIGS. 1 and 2, the device for carrying out interventions 1 comprises at least one first robot arm 5 and at least one second robot arm 6. Each robot arm 5, 6 is provided at its upper end 61, 62 with one or more tools 63, 64. Each robot arm 5, 6 is attached to the upper end support 3, and this will be described below. The robot arms 5, 6 and the tools 63, 64 enable remote—controlled execution of a given task on the electrical transmission line assembly L. Each robot arm 5, 6 can be mono—articulated or poly—articulated. Each robot arm 5, 6 and each tool 63, 64 is remote—controlled in its movements and its actions by a remote—control unit 100 which can be located on the ground. According to an embodiment of the invention, the remote control unit 100 communicates, via a wireless telecommunication connection, with the robot arms 5, 6 and the tools 63, 64, in order to send instructions for movement and actions to the robot arms 5, 6 and to the tools 63, 64. The remote control unit 100 comprises a control interface 101 that can be actuated by a person and may comprise a screen 102 for visualising an image captured by a camera (not shown) for visualisation of the robot arms 5, 6 and of the electrical transmission line assembly L. Such a camera can be provided on each robot arm 5, 6 and/or on each platform 7, 8.

According to an embodiment of the invention, the first robot arm 5 can be in contact with a first portion of the electrical transmission line assembly L, while the second robot arm 6 can be contact with a second portion of the electrical transmission line assembly L. The second portion of the electrical transmission line assembly L can be at a distance from the first portion of the electrical transmission line assembly L and can be at not the same electrical potential as the first portion of the electrical transmission line assembly L. There may thus be an AC voltage (for example greater than 10 kV, and for example equal to 20 kV) between the first portion of the electrical transmission line assembly L and the second portion of the electrical transmission line assembly L. For example, the given task executed by the robot arms 5, 6 may be that the first portion of the electrical transmission line assembly L is held by the first robot arm 5 and the second portion of the electrical transmission line assembly L is manipulated by the second robot arm 6.

In FIGS. 1, 2 and 4, the device 1 for carrying out interventions comprises a first electrically insulating tube 9 and a second electrically insulating tube 10, located at a certain distance relative to the first electrically insulating tube 9 in a direction T, which is transverse to the second electrically insulating tube 10. The first robot arm 5 is attached to a left platform 7, itself attached to the left side 91 of the first electrically insulating tube 9 and to the left side 101 of the second electrically insulating tube 10, which is located facing the left side 91 of the first electrically insulating tube 9 in direction T and at a distance therefrom. The second robot arm 6 is attached to a right platform 8, itself attached to the right side 92 of the first electrically insulating tube 9 and to the right side 102 of the first electrically insulating tube 9, which is located facing the right side 92 of the first electrically insulating tube 9 in direction T and at a distance therefrom.

According to an embodiment of the invention, the left side 91 is connected to the right side 92 via the portion 93 (called the middle portion 93) of the first electrically insulating tube 9, this middle portion 93 therefore being of non—zero length LS in the first direction of extension D1 of the first tube 9 between its left side 91 and its right side 92. The left side 101 is connected to the right side 102 via the portion 103 (called the middle portion 103) of the second electrically insulating tube 10, this middle portion 103 therefore being of non—zero length LS in the second direction of extension D2 of the second tube 10 between its left side 101 and its right side 102. The middle portion 93 of the first electrically insulating tube 9 and the middle portion 103 of the second electrically insulating tube 10 are attached to the end support 3 of the self—propelled lifting machine 2. The middle portion 93 of the first electrically insulating tube 9 and the middle portion 103 of the second electrically insulating tube 10 are located at a distance from one another and face each other.

The first robot arm 5 is thus electrically insulated from the second robot arm 6 and from the lifting machine 2, with the second robot arm 6 also electrically insulated from the lifting machine 2, in order to enable interventions to be carried out on the electrical transmission line assembly L by enabling the personnel to remain on the ground.

According to an embodiment of the invention, the first electrically insulating tube 9 is configured to have a first electrical strength greater than 50 kV per 30 cm length of this first tube 9 in the first direction of extension D1. For example, the first electrically insulating tube 9 is configured to have a first electrical strength of 100 kV per 30 cm length of this first tube 9 in the first direction of extension D1. According to an embodiment of the invention, the first electrically insulating tube 9 comprises a longitudinal cylinder, which extends from right to left and is made of glass fibres and epoxy resin, the longitudinal cylinder being filled with a polyurethane foam. According to an embodiment of the invention, the first electrically insulating tube 9 has a bending strength greater than 250 kg.

According to an embodiment of the invention, the second electrically insulating tube 10 is configured to have a second electrical strength greater than 50 kV per 30 cm length of this second tube 10 in the second direction of extension D2. For example, the second electrically insulating tube 10 is configured to have a second electrical strength greater than 50 kV per 30 cm length of this second tube 10 in the second direction of extension D2. According to an embodiment of the invention, the second electrically insulating tube 10 comprises a longitudinal cylinder, which extends from right to left and is made of glass fibres and epoxy resin, the longitudinal cylinder being filled with a polyurethane foam. According to an embodiment of the invention, the second insulating tube 10 has a bending strength greater than 250 kg.

According to an embodiment of the invention, the first electrical strength and the second electrical strength can likewise be provided by the fact that the end support 3 is separated by a first safety distance DS1 greater than or equal to 10 centimetres relative to the left platform 7 along each of the electrically insulating tubes 9 and 10 in the first and second directions D1 and D2.

According to an embodiment of the invention, the first electrical strength and the second electrical strength can likewise be provided by the fact that the end support 3 is separated by a second safety distance DS2 greater than or equal to 10 centimetres relative to the right platform 8 along each of the electrically insulating tubes 9 and 10 in the first and second directions D1 and D2.

According to an embodiment of the invention, the first electrically insulating tube 9 is geometrically parallel to the second electrically insulating tube 10, and the first direction of extension D1 is geometrically parallel to the second direction of extension D2. According to another embodiment of the invention, the first electrically insulating tube 9 is not geometrically parallel to the second electrically insulating tube 10 and can be slightly oblique relative to the second electrically insulating tube 10, and the first direction of extension D1 is not geometrically parallel to the second direction of extension D2 and can be slightly oblique relative to the first direction of extension D1.

According to an embodiment of the invention, the end support 3 of the self—propelled lifting machine 2 is formed by or comprises a left side beam 31 and a right side beam 32, which extend in the direction T transverse to the portions 93 and 103 of the electrically insulating tubes 9 and 10. The left side beam 31 is at a distance from and faces the right side beam 32. The left side beam 31 is attached to the portions 93 and 103 of the electrically insulating tubes 9 and 10. The right side beam 32 is attached to the portions 93 and 103 of the electrically insulating tubes 9 and 10. The left side beam 31 is connected to the side beam 32 via a connection element 33, extending at least in the directions of extension D1 and D2 and able to comprise a third beam. The connection element 33 is attached to the end 110 of an upper lifting element 11 of the lifting machine 2, either directly or via an intermediate support. The upper lifting element 11 is movable, at least in height, relative to the lower base 4.

According to an embodiment of the invention, the lifting machine 2 comprises one or more lifting elements, which are articulated one after the other via one or more axes of rotation between the end support 3 and the lower base 2. For example, four lifting elements 11, 12, 13, 14 are articulated successively by four axes 16, 17, 18, 19 of rotation relative to the base 4, as illustrated in FIG. 1. Of course, a smaller or larger number of lifting elements than four and a smaller or larger number of axes of rotation than four can be provided.

According to an embodiment of the invention, a first sleeve 21 encloses the left side 91 of the electrically insulating tube 9 in order to attach this left side 91 to the left platform 7, as illustrated in FIG. 4. Likewise, another first sleeve 22 encloses the left side 101 of the electrically insulating tube 10 in order to attach this left side 101 to the left platform 7.

According to an embodiment of the invention, a second sleeve 23 encloses the right side 92 of the electrically insulating tube 9 in order to attach this right side 92 to the right platform 8.

According to an embodiment of the invention, another second sleeve 24 encloses the right side 102 of the electrically insulating tube 10 in order to attach this right side 102 to the right platform 8.

According to an embodiment of the invention, a third sleeve 25 encloses the portion 93 of the electrically insulating tube 9 in order to attach this portion 93 to the end support 3 of the self-propelled lifting machine 2.

According to an embodiment of the invention, another third sleeve 26 encloses the portion 103 of the electrically insulating tube 10 in order to attach this portion 103 to the end support 3 of the self-propelled lifting machine 2.

Of course, one, several or all of the sleeves 21, 22, 23, 24, 25, 26 can be provided.

A possible exemplary embodiment of the first sleeves 21 and 22, second sleeves 23 and 24, and third sleeves 25 and 26, is described below with reference to FIGS. 5 to 8. Of course, the left platform 7, right platform 8 and end support 3 can be attached to the insulating tubes 9 and 10 by connection members other than the sleeves 21, 22, 23, 24, 25, 26.

In the embodiment of FIGS. 5 to 8, each sleeve 21, 22, 23, 24, 25, 26 comprises a first part 41 articulated via a first longitudinal axis of rotation 45 on a second part 42. In the clamping position, as illustrated in FIGS. 5 and 8, the first part 41 and the second part 42 delimit a cylindrical interior space 43, 44, in which the left side 91 of the electrically insulating tube 9, and/or the left side 101 of the electrically insulating tube 10, and/or the right side 92 of the electrically insulating tube 9, and/or the right side 102 of the electrically insulating tube 10, and/or the portion 93 of the electrically insulating tube 9, and/or the portion 103 of the electrically insulating tube 10, is clamped. The interior space 43, 44 is, for example, circular cylindrical, around a direction parallel to the first longitudinal axis of rotation 45. For example, the first part 41 is in the form of a semi-cylindrical jaw delimiting a first semi-cylindrical interior space 43, and the second part 42 is in the form of a semi-cylindrical jaw delimiting a second semi-cylindrical interior space 44, with the first longitudinal axis of rotation 45 provided at one edge of parts 41 and 42. The diameter of the first semi-cylindrical interior space 43, as well as the diameter of the second semi-cylindrical interior space 44, corresponds to the outer diameter of the left side 91 of the electrically insulating tube 9, and/or of the left side 101 of the electrically insulating tube 10, and/or of the right side 92 of the electrically insulating tube 9, and/or of the right side 102 of the electrically insulating tube 10, and/or of the portion 93 of the electrically insulating tube 9, and/or of the portion 103 of the electrically insulating tube 10.

In addition, each sleeve 21, 22, 23, 24, 25, 26 comprises clamping means 46, for example a clamping screw 46, which is articulated relative to the second part 42 via a second longitudinal axis of rotation 47. The second longitudinal axis of rotation 47 is at a distance from the first longitudinal axis of rotation 45 and also extends along the semi-cylindrical interior spaces 43, 44. The first part 41 comprises, at a distance from the first longitudinal axis of rotation 45, a clamping hook 50, which delimits an opening 51 capable of receiving the clamping screw 46.

Each sleeve 21, 22, 23, 24, 25, 26 can be put in a released position beforehand, as shown in FIG. 5, wherein the second part 42 and the first part 41 are separated from one another and the clamping means (the clamping screw 46) are at a distance from the opening 51 of the clamping hook 50. This makes it possible to insert the left side 91 of the electrically insulating tube 9, and/or the left side 101 of the electrically insulating tube 10, and/or the right side 92 of the electrically insulating tube 9, and/or the right side 102 of the electrically insulating tube 10, and/or the portion 93 of the electrically insulating tube 9, and/or the portion 103 of the electrically insulating tube 10 into the first and second semi-circular interior spaces 43, 44 of the parts 41 and 42 in the release position. The second part 42 comprises, between its longitudinal edges, a through-hole 52 transverse to the first and second longitudinal axes of rotation 45, 47. In the release position, a connection pin 48 can be screwed into the through-hole 52. This connection pin 48 comprises an outer connecting head 53, as illustrated, for example, in FIG. 7. The outer connecting head 53 is integral with a second screw 54 inserted in the through-hole 52, with a nut 55 screwed to the end 56 of the screw 54 and close to the inner face of the hole 52 facing the interior space 44 in order to attach the connection pin 48 to the second part 42. The connection pin 48 is used to be attached to the left platform 7, or to the right platform 8, or to the end support 3 and, for this purpose, can comprise another through-hole 57 enabling the passage, for example, of a member for attaching to the left platform 7, or to the right platform 8, or to the end support 3, such as an attachment bolt for example.

In order to move each sleeve 21, 22, 23, 24, 25, 26 from the release position to the clamping position, the first part 41 and the second part 42 are rotated relative to one another about the first longitudinal axis of rotation 45, in order to bring them closer in a closure position on the electrically insulating tube 9 or 10, which is therefore clamped in the first and second semi—cylindrical interior spaces 43, 44 between the first part 41 and the second part 42. In this closure position, the clamping screw 46 is rotated about the second longitudinal axis of rotation 47 in order to insert it in the opening 51 of the clamping hook 50. Then, another clamping nut 49 is screwed onto the clamping screw 46 against the clamping hook 50, which is then positioned between the second longitudinal axis of rotation 47 and the other nut 49, in order to attach each sleeve 21, 22, 23, 24, 25, 26 on the left side 91 of the electrically insulating tube 9, and/or the left side 101 of the electrically insulating tube 10, and/or the right side 92 of the electrically insulating tube 9, and/or the right side 102 of the electrically insulating tube 10, and/or the portion 93 of the electrically insulating tube 9, and/or the portion 103 of the electrically insulating tube 10. In the final clamping position, the connection pin 48 is attached to the left platform 7 or to the right platform 8 or to the end support 3.

Of course, the embodiments, features, possibilities and examples described above can be combined with one another or be selected independently from one another.

1. A device for carrying out interventions on an electrical transmission line assembly, comprising a self—propelled lifting machine for lifting a mobile end support relative to a lower base of the self—propelled lifting machine, at least one first robot arm and at least one second robot arm, which are provided with tools for remote—controlled execution of a given task on the electrical transmission line assembly and which are attached to the mobile end support,
the first robot arm and the second robot arm are respectively attached to a left platform and to a right platform, which are respectively attached to a left side and a right side of at least two electrically insulating tubes,
the left sides of the at least two electrically insulating tubes being located distant from one another and facing each other,
the right sides of the at least two electrically insulating tubes being located distant from one another and facing each other,
the left side of each of the at least two electrically insulating tubes being connected to its right side by a portion of the electrically insulating tube and being distant from its right side,
the portions of the at least two electrically insulating tubes being attached to the mobile end support of the self—propelled lifting machine.

2. The device according to claim 1, wherein the portions of the at least two electrically insulating tubes, to which the mobile end support of the self-propelled lifting machine is attached, are located distant from one another and facing each other.

3. The device according to claim 1, wherein each of the at least two electrically insulating tube has an electrical strength greater than 50 kV per 30 cm length of tube.

4. The device according to claim 1, wherein each of the at least two electrically insulating tube comprises a longitudinal cylinder, which is made of glass fibres and epoxy resin, the longitudinal cylinder being filled with a polyurethane foam.

5. The device according to claim 1, wherein the mobile end support is separated by a safety distance of at least 10 centimetres relative to the left platform or relative to the right platform along each of the at least two electrically insulating tubes.

6. The device according to claim 1, wherein the mobile end support of the self-propelled lifting machine comprises a left side beam and a right side beam, which are distant from one another, which extend transverse to the portions of the at least two electrically insulating tubes, which are attached to the portions of the at least two electrically insulating tubes and which are connected to one another by a connection element,
the connection element being attached to the end of at least one upper lifting element of the self-propelled lifting machine,
the at least one upper lifting element being mobile relative to the lower base.

7. The device according to claim 1, wherein the self-propelled lifting machine comprises at least one lifting element articulated via at least one axis of rotation relative to the lower base.

8. The device according to claim 1, wherein the left platform or the right platform is attached to at least one of the at least two electrically insulating tubes via at least one sleeve enclosing the at least one electrically insulating tube,
the portions of the at least two electrically insulating tubes being attached to the mobile end support of the self-propelled lifting machine via at least one other sleeve respectively enclosing the portions of the at least two electrically insulating tubes.

9. The device according to claim 8, wherein each of the at least one sleeve and of the at least one other sleeve comprises a first part delimiting a first semi-cylindrical interior space, a second part delimiting a second semi-cylindrical interior space, a first axis of rotation and a second axis of rotation which extend along the semi-cylindrical interior spaces and are distant from one another, a clamp and a connection pin,
the second part being articulated relative to the first part by the first axis of rotation,
the clamp being articulated relative to the second part by the second axis of rotation,
the first part comprising a clamping hook, which is located distant from the first axis of rotation and which delimits an opening capable of receiving the clamp,
the second part comprising a through-hole transverse to the first axis of rotation and to the second axis of rotation, the connection pin being capable of being attached in the through—hole and comprising an outer connecting head,
each of the at least one sleeve and of the at least one other the sleeve being capable of occupying a release position, in which the second part and the first part are open relative to one another and the clamp is at a distance from the opening of the clamping hook in order to allow one of the at least two electrically insulating tubes to be inserted in the first semi—cylindrical interior space and in the second semi—cylindrical interior spaces,
each of the at least one sleeve and of at least one other the sleeve being able to occupy a clamping position, in which the first part and the second part are closed on one another, the one of the at least two electrically insulating tubes is clamped in the first semi—cylindrical interior space and in the second semi—cylindrical interior spaces, between the first part and the second part, the clamp is clamped against the opening of the clamping hook, in order to attach the sleeve on the one of the at least two electrically insulating tubes, the connection pin is attached in the through—hole and the outer connecting head is positioned on an outside of the second part- and is attached to the left platform or to the right platform or to the mobile end support.
